(19) United States
(12) Patent Application Publication
(10) Pub. No.: US 2025/0321881 A1
(43) Pub. Date: Oct. 16, 2025

(54) STORAGE DEVICE FOR PERFORMING GARBAGE COLLECTION, OPERATING METHOD THEREOF, AND COMPUTING SYSTEM INCLUDING THE STORAGE DEVICE

(71) Applicant: SK hynix Inc., Gyeonggi-do (KR)

(72) Inventor: Chang Han KIM, Gyeonggi-do (KR)

(21) Appl. No.: 18/896,897

(22) Filed: Sep. 26, 2024

(30) Foreign Application Priority Data
Apr. 16, 2024 (KR) 10-2024-0050682

(51) Int. Cl. G06F 12/02

(52) U.S. Cl. CPC G06F 12/0246; G06F 2212/7205

(57) ABSTRACT

A storage device for efficiently performing garbage collection may include a memory device including a plurality of zones corresponding to groups of consecutive logical addresses provided from a host device, the plurality of zones including a first zone and a second zone, and a memory controller for receiving a garbage collection request from the host device, and controlling, in response to the garbage collection request, the memory device to store, in the second zone, a plurality of valid data items stored in the first zone. The garbage collection request may include first identification information identifying the first zone, a plurality of first offset information items indicating positions at which the plurality of valid data items are stored in the first zone, second identification information identifying the second zone, and second offset information indicating positions at which the plurality of valid data items are to be stored in the second zone.

### CROSS-REFERENCE TO RELATED APPLICATION

The present application claims priority under 35 U.S.C. § 119(a) to Korean patent application number 10-2024-0050682 filed on Apr. 16, 2024, the entire disclosure of which is incorporated by reference herein.

### BACKGROUND

### 1. Field of Invention

Embodiments of the present disclosure generally relate to a semiconductor device, and more particularly, to a storage device, an operating method thereof, and a computing system including the storage device.

### 2. Description of Related Art

A storage device is a device which stores data under the control of a host device including a computer, a mobile terminal such as a smartphone or a tablet, and various electronic devices. The storage device may include a memory device which stores data and a memory controller which controls the memory device. The storage device translates a logical address transferred from the host device into a physical address to be used therein, and accordingly, a logical area of the host device and a physical area of the storage device are related to each other.

The host device may manage the logical area by using a zone as a unit. The zone may be mapped one-to-one to the physical area of the storage device to be managed. The host device may control a garbage collection. For example, when a zone for storing data is insufficient, the host device may move valid data included in a target zone to a new zone and reset the target zone, thereby securing a free zone.

In order to move valid data to a new zone in garbage collection, the host device may receive valid data and re-provide the valid data to the storage device, to request the storage device to store the valid data in the new zone. Since the valid data is transmitted/received between the host device and the storage device, the time required for the garbage collection may be increased. Therefore, a plan for efficiently performing the garbage collection is required.

### SUMMARY

Embodiments of the present disclosure provide a storage device, an operating method thereof, and a computing system including the storage device, in which a garbage collection request including information on a position to which valid data is to be moved is received from a host device, so that garbage collection can be efficiently performed since no process of transmitting/receiving valid data between the host device and the storage device exists.

In accordance with an embodiment of the present disclosure, there is provided a storage device including a memory device including a plurality of zones corresponding to groups of consecutive logical addresses provided from a host device, the plurality of zones including a first zone and a second zone; and a memory controller configured to receive a garbage collection request from the host device, and control, in response to the garbage collection request, the memory device to store, in the second zone, a plurality of valid data items stored in the first zone, wherein the garbage collection request includes first identification information identifying the first zone, a plurality of first offset information items indicating positions at which the plurality of valid data items are stored in the first zone, second identification information identifying the second zone, and second offset information indicating positions at which the plurality of valid data items are to be stored in the second zone.

In accordance with another embodiment of the present disclosure, there is provided a method of operating a storage device, the method including receiving, from a host device, first identification information identifying a first zone among a plurality of zones of a memory device, a plurality of first offset information items indicating positions at which a plurality of valid data items are stored in the first zone, second identification information identifying a second zone among the plurality of zones, and second offset information indicating positions at which the plurality of valid data items are to be stored in the second zone; acquiring a plurality of first physical addresses indicating memory areas in which the plurality of valid data items are stored, based on the first identification information and the plurality of first offset information items; reading the plurality of valid data items from memory areas indicated by the plurality of first physical addresses, the memory areas included in the first zone; acquiring a plurality of second physical addresses indicating memory areas in which the plurality of valid data items are to be stored, based on the second identification information and the second offset information; and storing the plurality of read valid data items in memory areas indicated by the plurality of second physical addresses included in the second zone.

In accordance with still another embodiment of the present disclosure, there is provided a computing system including a host device configured to provide, when a garbage collection is requested, first identification information identifying a first zone among a plurality of zones, first offset information including distance information from a start address of the first zone to an address indicating a first memory area in which valid data is stored, second identification information identifying a second zone among the plurality of zones, and second offset information including distance information from a start address of the second zone to an address indicating a second memory area in which the valid data is to be stored; and a storage device including the plurality of zones and configured to receive, from the host device, the first identification information, the first offset information, the second identification information, and the second offset information, and move the valid data stored in the first memory area to the second memory area, based on the first identification information, the first offset information, the second identification information, and the second offset information.

### BRIEF DESCRIPTION OF THE DRAWINGS

Various embodiments of the present disclosure will now be described more fully hereinafter with reference to the accompanying drawings; however, the embodiments may be embodied in different forms and should not be construed as limited to the embodiments set forth herein. Rather, these embodiments are provided so that this disclosure will be thorough and complete, and will fully convey the scope of the embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a computing system in accordance with an embodiment of the present disclosure.

FIG. 2 is a diagram illustrating a zone in accordance with an embodiment of the present disclosure.

FIG. 3 is a diagram illustrating logical addresses allocated to a zone in accordance with an embodiment of the present disclosure.

FIG. 4 is a diagram illustrating map data indicating a mapping relationship between offset information and a physical address in accordance with an embodiment of the present disclosure.

FIG. 5 is a diagram illustrating an example in which valid data is read in a sacrificial zone in accordance with an embodiment of the present disclosure.

FIG. 6 is a diagram illustrating an example in which read valid data is stored in a new zone in accordance with an embodiment of the present disclosure.

FIG. 7 is a flowchart illustrating an operating method of a storage device in accordance with an embodiment of the present disclosure.

FIG. 8 is a diagram illustrating a memory controller in accordance with an embodiment of the present disclosure.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and should not be construed as limited to the embodiments set forth herein.

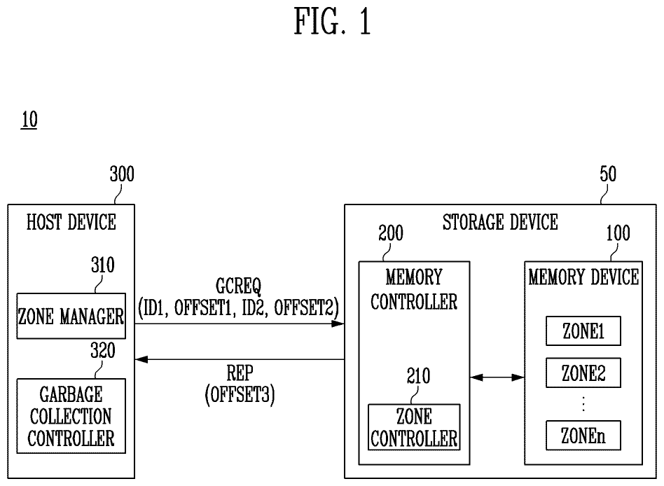

FIG. 1 is a diagram illustrating a computing system 10 in accordance with an embodiment of the present disclosure.

Referring to FIG. 1, the computing system 10 may include a storage device 50 and a host device 300.

The storage device 50 may be a device for storing data under the control of the host device 300, such as a mobile phone, a smartphone, an MP3 player, a laptop computer, a server computer, a desktop computer, a game console, a TV, a tablet PC or an in-vehicle infotainment.

The storage device 50 may include a memory device 100 and a memory controller 200 which controls an operation of the memory device 100.

The storage device 50 may be configured as any of storage devices, such as a solid state drive (SSD), a multimedia card in the form of an MMC and an eMMC, a Universal Serial Bus (USB) storage device, a Universal Flash Storage (UFS) device, a peripheral component interconnection (PCI) card type storage device, a PCI express (PCI-e or PCIe) card type storage device, a Compact Flash (CF) card, a Smart Media Card (SMC), and a memory stick according to a communication scheme with the host device 300.

The storage device 50 may be manufactured as any of various package types. For example, the storage device 50 may be manufactured as any various package types such as a Package-On-Package (POP), a System-In-Package (SIP), a System-On-Chip (SOC), a Multi-Chip Package (MCP), a Chip-On-Board (COB), a Wafer-level Fabricated Package (WFP), and a Wafer-level Stack Package (WSP).

The memory device 100 may store data. The memory device 100 may include a plurality of memory blocks for storing data. Each memory block may include a plurality of memory cells.

In an embodiment, the memory device 100 may be a nonvolatile memory in which data does not disappear even when the supply of power is interrupted. In this specification, for convenience of description, a case where the memory device 100 is a NAND flash memory is described.

In an embodiment, the memory device 100 may receive a command and an address from the memory controller 200. The memory device 100 may perform an operation indicated by the command on an area selected by the address. For example, the memory device 100 may perform a write operation (or program operation), a read operation, and an erase operation.

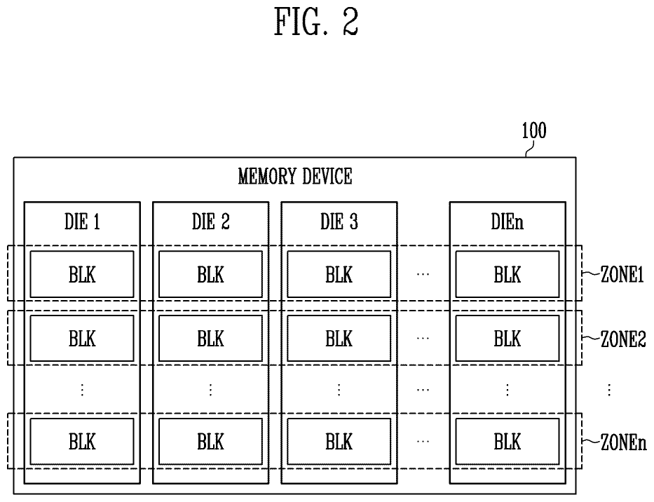

In an embodiment, the memory device 100 may include a plurality of zones ZONE1 to ZONEn. Each zone may include a plurality of memory blocks and may be allocated to a logical address group configured with consecutive logical addresses provided from the host device 300. The zone will be described in detail with reference to FIG. 2.

The memory controller 200 may control overall operations of the storage device 50.

When power is applied to the storage device 50, the memory controller 200 may execute firmware (FW). When the memory device 100 is a flash memory device, the FW may include a Host Interface Layer (HIL) for controlling communication with the host device 300, a Flash Translation Layer (FTL) for controlling communication between the host device 300 and the memory device 100, and a Flash Interface Layer (FIL) for controlling communication with the memory device 100.

In an embodiment, the memory controller 200 may receive data and a Logical Block Address (LBA) from the host device 300, and translate the LBA into a Physical Block Address (PBA) indicating addresses of memory cells included in the memory device 100, in which data is to be stored. In this specification, the LBA and a “logic address” or “logical address” may be used with the same meaning. In this specification, the PBA and a “physical address” may be used with the same meaning.

In an embodiment, the memory controller 200 may provide the memory device 100 with a command, an address or data, which corresponds to a program operation, a read operation, an erase operation or the like, to perform the corresponding operation according to a request of the host device 300.

In an embodiment, the memory controller 200 may autonomously generate a command, an address, and data, regardless of any request from the host device 300, and transmit the command, the address, and the data to the memory device 100. For example, the memory controller 200 may provide the memory device 100 with a command, an address, and data, which are used to perform program and read operations accompanied in performing internal operations such as a wear leveling operation, a read reclaim operation, a garbage collection operation, and the like.

In an embodiment, the memory controller 200 may include a zone controller 210.

The zone controller 210 may control a read operation, a program operation, a reset operation, and the like on a zone according to a request of the host device 300.

In an embodiment, the zone controller 210 may receive a garbage collection request GCREQ from the host device 300, and control the memory device 100 to store, in a new zone, a plurality of valid data items stored in a sacrificial zone among the plurality of zones ZONE1 to ZONEn. The sacrificial zone is a target zone of garbage collection, and may represent a zone as a target of a reset operation for the purpose of securing a free zone.

In an embodiment, the garbage collection request GCREQ may include first identification information ID1 identifying the sacrificial zone, a plurality of first offset information items OFFSET1 indicating positions at which the plurality of valid data items are stored in the sacrificial zone, second identification information ID2 identifying the new zone in which the plurality of valid data items are to be stored, and second offset information OFFSET2 indicating positions at which the plurality of valid data items are to be stored in the new zone.

For example, the zone controller 210 may receive, from the host device 300, the first identification information ID1, the first offset information OFFSET1, the second identification information ID2, and the second offset information OFFSET2. Further, the zone controller 210 may move the valid data items stored in the sacrificial zone to the new zone, based on the first identification information ID1, the first offset information OFFSET1, the second identification information ID2, and the second offset information OFFSET2.

Also, the zone controller 210 may move the valid data items stored in the sacrificial zone to the new zone, and then perform a reset operation on the sacrificial zone.

In an embodiment, after the zone controller 210 moves the valid data items stored in the sacrificial zone to the new zone, the zone controller 210 may provide the host device 300 with three offset information items indicating a start position of an empty memory area included in the new zone as a response REP to the garbage collection request GCREQ.

The host device 300 may communicate with the storage device 50, using at least one of various communication standards or interfaces, such as a Universal Serial bus (USB), a Serial AT Attachment (SATA), a High Speed InterChip (HSIC), a Small Computer System Interface (SCSI), Firewire, a Peripheral Component Interconnection (PCI), a PCI express (PCIe), a Non-Volatile Memory express (NVMe), a universal flash storage (UFS), a Secure Digital (SD), a Multi-Media Card (MMC), an embedded MMC (eMMC), a Dual In-line Memory Module (DIMM), a Registered DIMM (RDIMM), and a Load Reduced DIMM (LRDIMM).

The host device 300 may include an operation system (OS), an application executed on the OS, a file system which allocates a logical address at which data is to be stored or determine a logical address at which data is to be read, and the like.

In an embodiment, the host device 300 may include a zone manager 310 and a garbage collection controller 320.

The zone manager 310 may manage the plurality of zones ZONE1 to ZONEn.

In an embodiment, the zone manager 310 may allocate a logical address group to each of the plurality of zones ZONE1 to ZONEn. The zone manager 310 may request the storage device 50 to transmit state information of the plurality of zones ZONE1 to ZONEn, and request the storage device 50 to perform a read operation, a write operation, a reset operation, and the like, based on the state information of the plurality of zones. The state information may include information of an open state, a closed state, and the like. Also, the zone manager 310 may store a write pointer indicating a position at which data is to be stored in each zone.

The garbage collection controller 320 may control a garbage collection operation on the plurality of zones ZONE1 to ZONEn. For example, when the number of free zones in which data can be stored among the plurality of zones ZONE1 to ZONEn is a threshold value or less, the garbage collection controller 320 may control the garbage collection operation. The garbage collection controller 320 may determine a sacrificial zone by considering a number of valid pages in the zone, state information of the zone, and the like. For example, the garbage collection controller 320 may determine, as the sacrificial zone, a zone in the closed state among the plurality of zones ZONE1 to ZONEn, and determine, as the sacrificial zone, a zone having a large number of valid pages among zones in the closed state.

In an embodiment, when garbage collection is triggered, the garbage collection controller 320 may generate first identification information ID1, first offset information OFFSET1, second identification information ID2, and second offset information OFFSET2 and provide the first identification information ID1, the first offset information OFFSET1, the second identification information ID2, and the second offset information OFFSET2 to the storage device 50.

In accordance with the embodiment of the present disclosure, a position at which valid data is stored in a sacrificial zone and a position at which the valid data is to be stored in a new zone are provided together when the garbage collection request GCREQ is received, so that the time required for garbage collection can be reduced and the garbage collection can be efficiently performed since no process of transmitting/receiving valid data between the host device 300 and the storage device 50 exists.

FIG. 2 is a diagram illustrating a zone of a memory device in accordance with an embodiment of the present disclosure.

Referring to FIG. 2, each of the plurality of zones ZONE1 to ZONEn may include a plurality of memory blocks. In an embodiment, numbers of memory blocks included in the plurality of zones ZONE1 to ZONEn may be different from each other or be the same. For example, the memory device 100 may include a plurality of dies DIE1 to DIEn. Each zone may include a plurality of memory blocks included in different dies.

In some embodiments, unlike the example shown in FIG. 2, each zone may be configured within one memory block. That is, each zone may be configured with a memory area configured in at least an erase operation unit.

The zone may be an area in which data corresponding to logical addresses input from the host device 300 is stored. Specifically, the plurality of zones ZONE1 to ZONEn may be areas in which data corresponding to allocated logical address groups are stored, respectively. Each of the logical address groups may include consecutive logical addresses.

In some embodiments, the plurality of zones ZONE1 to ZONEn may have an open state and a closed state according to a request of the host device 300. A zone having the open state may be designated as an open zone, and a zone having the closed state may be designated as a closed zone. The open zone means a zone in which data can be written, i.e., a writable zone. The memory controller 200 may perform a write operation on data in the open zone. The closed zone means a zone in which no data can be written. The memory controller 200 may perform a write operation on data in the closed zone until before the state of the closed zone is changed to the open state.

In addition, each of the plurality of zones ZONE1 to ZONEn may perform a reset operation according to a reset request input from the host device 300. The reset operation may be an operation of erasing data stored in memory blocks included in a zone which becomes a target of the reset request. For example, when a reset request for a first zone ZONE1 is input, the memory device 100 may perform an erase operation on memory blocks included in the first zone ZONE1.

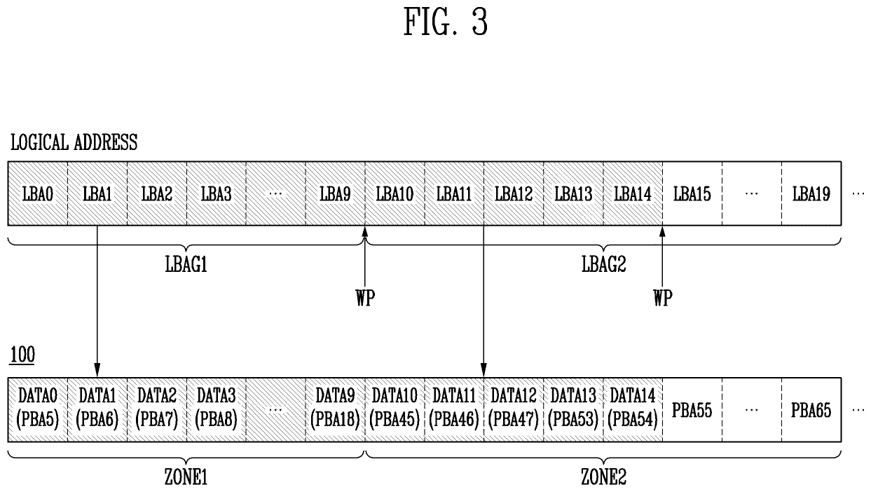

FIG. 3 is a diagram illustrating logical addresses allocated to a zone in accordance with an embodiment of the present disclosure.

Referring to FIG. 3, the plurality of zones ZONE1 to ZONEn may be allocated to logical address groups, respectively. For example, the first zone ZONE1 may be allocated to a first logical address group LBAG1. The first logical address group LBAG1 may include consecutive zeroth to ninth logical addresses LBA0 to LBA9. A second zone ZONE2 may be allocated to a second logical address group LBAG2. The second logical address group LBAG2 may include consecutive tenth to nineteenth logical addresses LBA10 to LBA19.

The first zone ZONE1 may store data DATA0 to DATA9 corresponding to the zeroth to ninth logical addresses LBA0 to LBA9, which are received from the host device 300. A write pointer WP may indicate a position at which data corresponding to logical addresses is lastly stored in a zone or a start position of an empty memory area. Since data have been stored up to ninth data DATA9 corresponding to the ninth logical address LBA9 in the first zone ZONE1, a write pointer WP of the first zone ZONE1 may indicate a last position of the ninth logical address LBA9. In an embodiment, an offset of the write pointer WP of the first zone ZONE1 may be 10. The first zone ZONE1 may be in a state in which data are stored in all memory areas.

The second zone ZONE2 may store data DATA10 to DATA14 corresponding to the tenth to fourteenth logical addresses LBA10 to LBA14, which are received from the host device 300. Since data have been stored up to fourteenth data DATA14 corresponding to the fourteenth logical address LBA14 in the second zone ZONE2, a write pointer WP of the second zone ZONE2 may indicate the fifteenth logical address LBA15. In an embodiment, an offset of the write pointer WP of the second zone ZONE2 may be 5.

In an embodiment, one logical address may correspond to one physical address. Although logical addresses are consecutive, physical addresses corresponding to the corresponding logical addresses may be consecutive or may not be consecutive.

Although not described in the above-described example, each of the other zones except the first zone ZONE1 and the second ZONE2 may also be allocated to a logical address group in the same manner as the first zone ZONE1 and the second ZONE2.

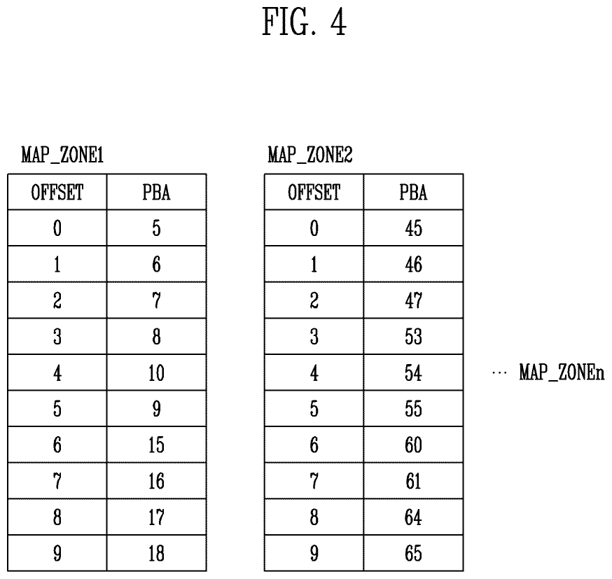

FIG. 4 is a diagram illustrating map data indicating a mapping relationship between offset information and a physical address in accordance with an embodiment of the present disclosure.

Referring to FIG. 4, the storage device 50 may store a plurality of map data items MAP_ZONE1 to MAP_ZONEn. For example, the plurality of map data items MAP_ZONE1 to MAP_ZONEn may be stored in the memory controller 200 or the memory device 100.

In an embodiment, each of the plurality of map data MAP_ZONE1 to MAP_ZONEn may include a mapping relationship between offset information OFFSET provided from the host device 300 on each of the plurality of zones ZONE1 to ZONEn and a physical address PBA indicating a position at which data is stored in the memory device 100.

For example, first map data MAP_ZONE1 may indicate a mapping relationship between offset information on the first zone ZONE1 and physical addresses. Specifically, in the first map data MAP_ZONE1, offset information 0 may be mapped to a fifth physical address PBA5, offset information 1 may be mapped to a sixth physical address PBA6, offset information 2 may be mapped to a seventh physical address PBA7, offset information 3 may be mapped to an eighth physical address PBA8, offset information 4 may be mapped to a tenth physical address PBA10, offset information 5 may be mapped to a ninth physical address PBA9, offset information 6 may be mapped to a fifteenth physical address PBA15, offset information 7 may be mapped to a sixteenth physical address PBA16, offset information 8 may be mapped to a seventeenth physical address PBA17, and offset information 9 may be mapped to an eighteenth physical address PBA18.

Second map data MAP_ZONE2 may indicate a mapping relationship between offset information on the second zone ZONE2 and physical addresses. Specifically, in the second map data MAP_ZONE2, offset information 0 may be mapped to a forty-fifth physical address PBA45, offset information 1 may be mapped to a forty-sixth physical address PBA46, offset information 2 may be mapped to a forty-seventh physical address PBA47, offset information 3 may be mapped to a fifty-third physical address PBA53, offset information 4 may be mapped to a fifty-fourth physical address PBA54, offset information 5 may be mapped to a fifty-fifth physical address PBA55, offset information 6 may be mapped to a sixtieth physical address PBA60, offset information 7 may be mapped to a sixty-first physical address PBA61, offset information 8 may be mapped to a sixty-fourth physical address PBA64, and offset information 9 may be mapped to a sixty-fifth physical address PBA65.

Although not described in the above-described example, each of the other map data except the first map data MAP_ZONE1 and the second map data MAP_ZONE2 may also indicate a mapping relationship between offset information and physical addresses in the same manner as the first map data MAP_ZONE1 and the second map data MAP_ZONE2.

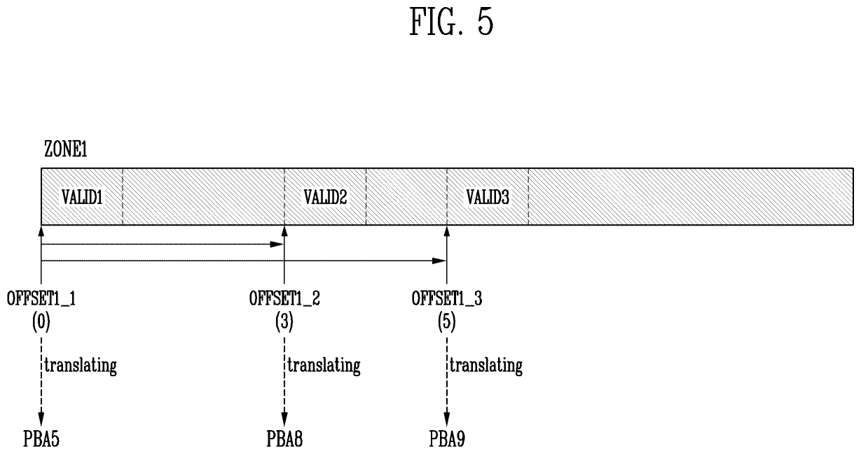

FIG. 5 is a diagram illustrating an example in which valid data is read in a sacrificial zone in accordance with an embodiment of the present disclosure.

In FIG. 5, it is illustrated that a sacrificial zone is the first zone ZONE1. In addition, a slashed or hatching area may represent a memory area in which data is stored.

Referring to FIGS. 4 and 5, in an embodiment, a plurality of first offset information items OFFSET1_1 to OFFSET1_3 on the first zone ZONE1 may include distance information from a start logical address of the first zone ZONE1 to a plurality of first logical addresses indicating memory areas in which a plurality of valid data items VALID1 to VALID3 are stored. The plurality of first logical addresses may correspond to a plurality of first physical addresses PBA5, PBA8, and PBA9 indicating the memory areas in which the plurality of valid data VALID1 to VALID3 are stored, respectively.

In an embodiment, the memory controller 200 may acquire the plurality of first physical addresses PBA5, PBA8, and PBA9 indicating the memory areas in which the plurality of valid data items VALID1 to VALID3 are stored, based on first identification information and the plurality of first offset information items OFFSET1_1 to OFFSET1_3.

For example, the memory controller 200 may determine the first map data MAP_ZONE1 on the first zone ZONE1 among the plurality of map data items, based on the first identification information. The memory controller 200 may acquire a plurality of first physical addresses mapped to the plurality of first offset information items OFFSET1_1 to OFFSET1_3, based on the determined first map data MAP_ZONE1. Specifically, since (1-1)th offset information OFFSET1_1 corresponds to 0, the (1-1)th offset information OFFSET1_1 may indicate the start logical address of the first zone ZONE1. The memory controller 200 may translate the offset information 0 into the fifth physical address PBA5, based on the first map data MAP_ZONE1. Since (1-2)th offset information OFFSET1_2 corresponds to 3, the (1-2)th offset information OFFSET1_2 may indicate a logical address distant by offset 3 from the start logical address of the first zone ZONE1. The memory controller 200 may translate the offset information 3 into the eighth physical address PBA8, based on the first map data MAP_ZONE1. Since (1-3)th offset information OFFSET1_3 corresponds to 5, the (1-3)th offset information OFFSET1_3 may indicate a logical address distant by offset 5 from the start logical address of the first zone ZONE1. The memory controller 200 may translate the offset information 5 into the ninth physical address PBA9, based on the first map data MAP_ZONE1.

In an embodiment, the memory controller 200 may control the memory device 100 to read the plurality of valid data items VALID1 to VALID3 from memory areas indicated by the plurality of first physical addresses PBA5, PBA8, and PBA9 included in the first zone ZONE1.

For example, the memory controller 200 may provide the memory device 100 with a read command and the plurality of first physical addresses PBA5, PBA8, and PBA9. The memory device 100 may read the plurality of valid data items VALID1 to VALID3 from the memory areas indicated by the plurality of first physical addresses PBA5, PBA8, and PBA9 and provide the plurality of valid data items VALID1 to VALID3 to the memory controller 200 in response to the read command.

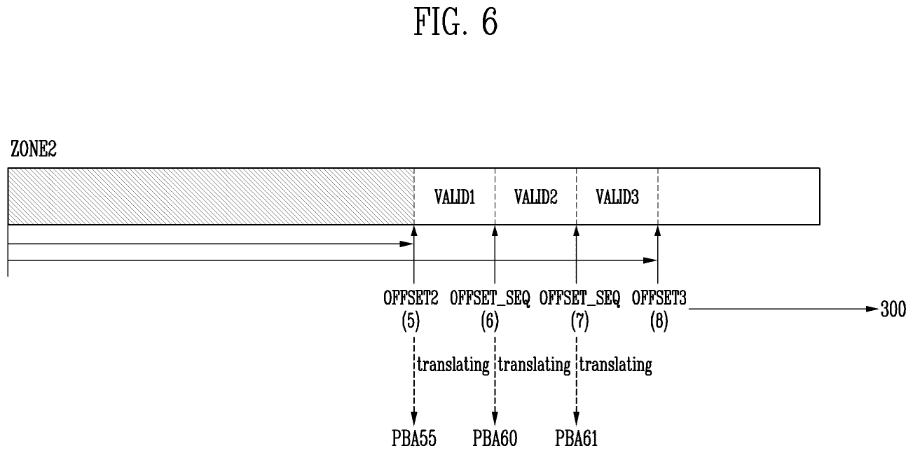

FIG. 6 is a diagram illustrating an example in which read valid data is stored in a new zone in accordance with an embodiment of the present disclosure.

In FIG. 6, it is illustrated that a new zone is the second zone ZONE2. In addition, a slashed or hatching area may represent a memory area in which data is stored.

Referring to FIGS. 4 and 6, in an embodiment, second offset information OFFSET2 may include distance information from a start logical address of the second zone ZONE2 to a second logical address indicating a memory area in which storing of a plurality of valid data items VALID1 to VALID3 is to be started.

In an embodiment, the memory controller 200 may acquire a plurality of second physical addresses PBA55, PBA60, and PBA61 indicating memory areas in which the plurality of valid data items VALID1 to VALID3 are to be stored, respectively, based on second identification information and the second offset information OFFSET2.

For example, the memory controller 200 may determine the second map data MAP_ZONE2 on the second zone ZONE2, based on the second identification information. The memory controller 200 may acquire the plurality of second physical addresses PBA55, PBA60, and PBA61 mapped to the second offset information OFFSET2 and offset information OFFSET_SEQ consecutive to the second offset information OFFSET2, based on the determined second map data MAP_ZONE2. Specifically, since the second offset information OFFSET2 corresponds to 5, the second offset information OFFSET2 may indicate a logical address distant by offset 5 from the start logical address of the second zone ZONE2. The memory controller 200 may translate the offset information 5 into the fifty-fifth physical address PBA55, based on the second map data MAP_ZONE2.

The memory controller 200 may determine the offset information OFFSET_SEQ consecutive to the second offset information OFFSET2. For example, the memory controller 200 may determine the offset information OFFSET_SEQ according to the number of the plurality of valid data items VALID1 to VALID3. Specifically, the memory controller 200 may determine the offset information OFFSET_SEQ such that the number of the offset information OFFSET_SEQ consecutive to the second offset information OFFSET2 accords with the number of the plurality of valid data items VALID1 to VALID3. Specifically, since two valid data items VALID2 and VALID3 exist except valid data VALID1 to be stored according to the second offset information OFFSET2, the memory controller 200 may determine two offset information items OFFSET_SEQ consecutive to the second offset information OFFSET2.

Since the two consecutive offset information items OFFSET_SEQ correspond to 6 and 7, respectively, the two consecutive offset information items OFFSET_SEQ may indicate logical addresses distant by offsets 6 and 7 from the start logical address of the second zone ZONE2. The memory controller 200 may translate the offset information items 6 and 7 respectively into the sixtieth physical address PBA60 and the sixty-first physical address PBA61, based on the second map data MAP_ZONE2.

In an embodiment, the memory controller 200 may control the memory device 100 to store the plurality of valid data items VALID1 to VALID3 in memory areas indicated by the plurality of second physical addresses PBA55, PBA60, and PBA61 included in the second zone ZONE2.

For example, the memory controller 200 may provide the memory device 100 with a write command, the plurality of valid data items VALID1 to VALID3, and the plurality of second physical addresses PBA55, PBA60, and PBA61. The memory device 100 may store the plurality of valid data items VALID1 to VALID3 in the memory areas indicated by the plurality of second physical addresses PBA55, PBA60, and PBA61 in response to the write command.

In an embodiment, after the plurality of valid data items VALID1 to VALID3 are stored in the second zone ZONE2, the memory controller 200 may provide the host device 300 with third offset information OFFSET3 including distance information from the start logical address of the second zone ZONE2 to a logical address indicating an empty memory area as a response to a garbage collection request.

For example, when a garbage collection operation is completed, the memory controller 200 may provide the host device 300 with the third offset information OFFSET3 indicating a position at which the valid data VALID3 is lastly stored in the second zone ZONE2 or a start position of the empty memory area. That is, the third offset information OFFSET3 may indicate a position at which a write operation can be started in the second zone ZONE2. When a write request for the second zone ZONE2 is subsequently received, the host device 300 may provide the write request to the storage device 50 with reference to the third offset information OFFSET3.

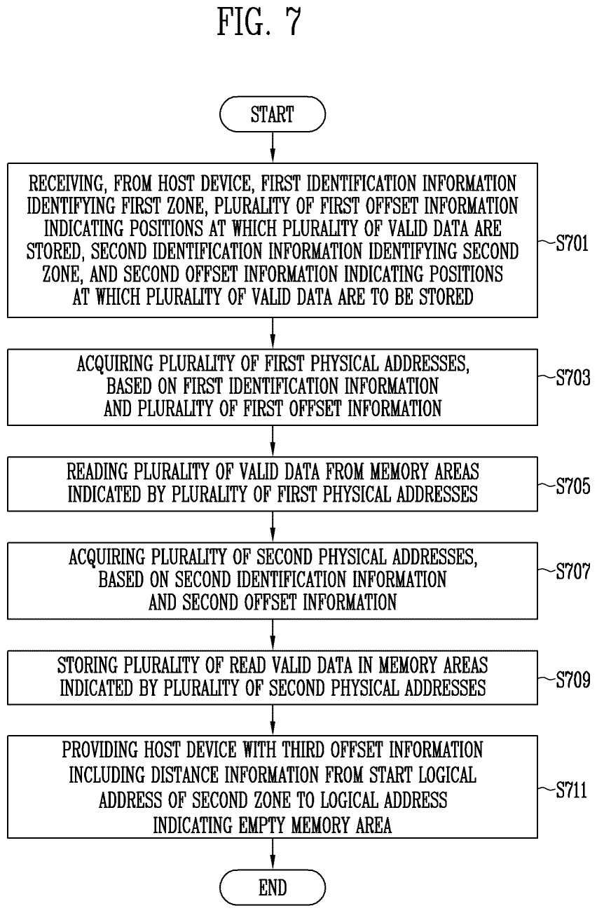

FIG. 7 is a diagram illustrating an operating method of a storage device in accordance with an embodiment of the present disclosure.

The operating method shown in FIG. 7 may be performed by the storage device 50 shown in FIG. 1.

Referring to FIG. 7, in S701, the storage device 50 may receive, from the host device 300, first identification information identifying a first zone, a plurality of first offset information items indicating positions at which a plurality of valid data items are stored in the first zone, second identification information identifying a second zone, and second offset information indicating positions at which the plurality of valid data items are to be stored in the second zone.

In S703, the storage device 50 may acquire a plurality of first physical addresses indicating memory areas in which the plurality of valid data items are stored, based on the first identification information and the plurality of first offset information items.

For example, the storage device 50 may determine map data on the first zone, based on the first identification information. Also, the storage device 50 may translate the plurality of first offset information items into the plurality of first physical addresses, based on the map data.

In S705, the storage device 50 may read the plurality of valid data items from the memory areas indicated by the plurality of first physical addresses included in the first zone.

In S707, the storage device 50 may acquire a plurality of second physical addresses indicating memory areas in which the plurality of valid data items are to be stored, based on the second identification information and the second offset information.

For example, the storage device 50 may determine map data on the second zone, based on the second identification information. Also, the storage device 50 may translate the second offset information and offset information consecutive to the second offset information into the plurality of second physical addresses, based on the map data.

In S709, the storage device 50 may store the plurality of read valid data items in the memory areas indicated by the plurality of second physical addresses included in the second zone.

In S711, the storage device 50 may provide the host device 300 with third offset information including distance information from a start logical address of the second zone to a logical address indicating an empty memory area as a response to a garbage collection request.

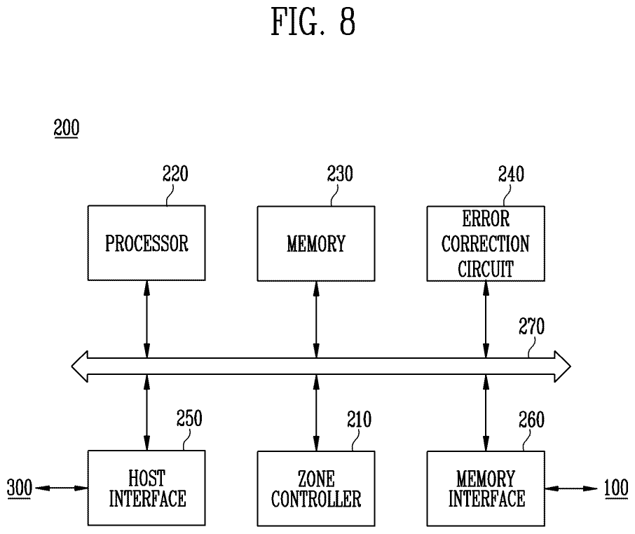

FIG. 8 is a diagram illustrating a memory controller in accordance with an embodiment of the present disclosure.

Referring to FIG. 8, the memory controller 200 may include a zone controller 210, a processor 220, a memory 230, an error correction circuit 240, a host interface 250, a memory interface 260, and a communication bus 270. The zone controller 210 shown in FIG. 8 represents the zone controller 210 shown in FIG. 1, and therefore, its detailed descriptions will be omitted.

The processor 220 may control a general operation of the memory controller 200.

In an embodiment, the processor 220 may execute firmware, a code, or one or more commands, including various information required when the memory controller 200 operates.

The memory 230 may be used as a buffer memory, a cache memory, a working memory, or the like.

Also, the memory 230 may store firmware, a code, or one or more commands, including various information required when the memory controller 200 operates.

The error correction circuit 240 may perform error connection when data is stored or when data is read. For example, the error correction circuit 240 may perform Error Correction Code (ECC) encoding, based on data to be written to the memory device 100. The encoded data may be transferred to the memory device 100. The error correction circuit 240 may perform ECC decoding on data received from the memory device 100.

The memory controller 200 may communicate with an external device (e.g., the host device 300, an application processor, or the like) through the host interface 250.

The memory controller 200 may communicate with the memory device 100 through the memory interface 260. The memory controller 200 may transmit, to the memory device 100, a command, an address, a control signal, and the like through the memory interface 260, and receive data from the memory device 100 through the memory interface 260.

The zone controller 210, the processor 220, the memory 230, the error correction circuit 240, the host interface 250, and the memory interface 260 may communicate with each other through the communication bus 270.

In accordance with the embodiments of the present disclosure, there can be provided a storage device, an operating method thereof, and a computing system including the storage device, in which garbage collection can be efficiently performed.

While the embodiments of the present disclosure have been shown and described with reference to certain embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described embodiments but should be determined by not only the appended claims but also the equivalents thereof.

In the above-described embodiments, all operations may be selectively performed or part of the operations may be omitted. In each embodiment, the operations are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

The embodiments of the present disclosure have been described in the drawings and specification. Although specific terminologies are used here, those are only to describe the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein. Furthermore, the embodiments may be combined to form additional embodiments.

What is claimed is:

1. A storage device comprising:
a memory device including a plurality of zones corresponding to groups of consecutive logical addresses provided from a host device, the plurality of zones including a first zone and a second zone; and
a memory controller configured to receive a garbage collection request from the host device, and control, in response to the garbage collection request, the memory device to store, in the second zone, a plurality of valid data items stored in the first zone,
wherein the garbage collection request includes first identification information identifying the first zone, a plurality of first offset information items indicating positions at which the plurality of valid data items are stored in the first zone, second identification information identifying the second zone, and second offset information indicating positions at which the plurality of valid data items are to be stored in the second zone.

2. The storage device of claim 1, wherein the plurality of first offset information items include distance information from a start logical address of the first zone to a plurality of first logical addresses indicating memory areas in which the plurality of valid data items are stored.

3. The storage device of claim 1, wherein the second offset information includes distance information from a start logical address of the second zone to a second logical address indicating a memory area in which storing of the plurality of valid data items is to be started.

4. The storage device of claim 1, wherein the memory controller stores map data indicating a mapping relationship between offset information provided from the host device on the plurality of zones and a physical address indicating a position at which data is stored in the memory device.

5. The storage device of claim 4, wherein the memory controller determines the map data on the first zone, based on the first identification information, and acquires a plurality of first physical addresses mapped to the plurality of first offset information items, based on the determined map data.

6. The storage device of claim 5, wherein the memory controller controls the memory device to read the plurality of valid data items from memory areas indicated by the plurality of first physical addresses included in the first zone.

7. The storage device of claim 4, wherein the memory controller determines the map data for the second zone, based on the second identification information, and acquires a plurality of second physical addresses mapped to the second offset information and offset information consecutive to the second offset information, based on the determined map data.

8. The storage device of claim 7, wherein the memory controller controls the memory device to store the plurality of valid data items in memory areas indicated by the plurality of second physical addresses included in the second zone.

9. The storage device of claim 1, wherein the memory controller stores the plurality of valid data items in the second zone, and then provides the host device with third offset information including distance information from a start logical address of the second zone to a logical address indicating an empty memory area.

10. A method of operating a storage device, the method comprising:
receiving, from a host device, first identification information identifying a first zone among a plurality of zones of a memory device, a plurality of first offset information items indicating positions at which a plurality of valid data items are stored in the first zone, second identification information identifying a second zone among the plurality of zones, and second offset information indicating positions at which the plurality of valid data items are to be stored in the second zone;
acquiring a plurality of first physical addresses indicating memory areas in which the plurality of valid data items are stored, based on the first identification information and the plurality of first offset information items;
reading the plurality of valid data items from memory areas indicated by the plurality of first physical addresses, the memory areas included in the first zone;
acquiring a plurality of second physical addresses indicating memory areas in which the plurality of valid data items are to be stored, based on the second identification information and the second offset information; and
storing the plurality of read valid data items in memory areas indicated by the plurality of second physical addresses included in the second zone.

11. The method of claim 10, wherein the plurality of first offset information items include distance information from a start logical address of the first zone to a plurality of first logical addresses indicating memory areas in which the plurality of valid data items are stored.

12. The method of claim 10, wherein the second offset information includes distance information from a start logical address of the second zone to a second logical address indicating a memory area in which storing of the plurality of valid data items is to be started.

13. The method of claim 10, wherein acquiring the plurality of first physical addresses includes:
determining map data on the first zone, based on the first identification information; and
translating the plurality of first offset information items into the plurality of first physical addresses, based on the map data.

14. The method of claim 10, wherein acquiring the plurality of second physical addresses includes:
determining map data on the second zone, based on the second identification information; and
translating the second offset information and offset information consecutive to the second offset information into the plurality of second physical addresses.

15. The method of claim 10, further comprising providing the host device with third offset information including distance information from a start logical address of the second zone to a logical address indicating an empty memory area, after storing the plurality of read valid data items.

16. A computing system comprising:
a host device configured to provide, when a garbage collection is requested, first identification information identifying a first zone among a plurality of zones, first offset information including distance information from a start address of the first zone to an address indicating a first memory area in which valid data is stored, second identification information identifying a second zone among the plurality of zones, and second offset information including distance information from a start address of the second zone to an address indicating a second memory area in which the valid data is to be stored; and
a storage device including the plurality of zones and configured to receive, from the host device, the first identification information, the first offset information, the second identification information, and the second offset information, and move the valid data stored in the first memory area to the second memory area, based on the first identification information, the first offset information, the second identification information, and the second offset information.

17. The computing system of claim 16, wherein the storage device acquires a first physical address indicating the first memory area, based on the first identification information and the first offset information, and reads the valid data from the first memory area, based on the first physical address.

18. The computing system of claim 16, wherein the storage device acquires a second physical address indicating the second memory area, based on the second identification information and the second offset information, and stores the valid data in the second memory area, based on the second physical address.

19. The computing system of claim 18, wherein the storage device acquires the plurality of second physical addresses by:
determining map data for the second zone, based on the second identification information; and
translating the second offset information and offset information consecutive to the second offset information into the plurality of second physical addresses.

20. The computing system of claim 18, wherein, after storing the valid data in the second memory area, the storage device provides the host device with third offset information including distance information from a start logical address of the second zone to a logical address indicating an empty memory area.
